(19) United States
(12) Patent Application Publication
(10) Pub. No.: US 2008/0208730 A1
(43) Pub. Date: Aug. 28, 2008

(54) Wave volatility measuring method

(76) Inventor: Danton Steven Long, Michigan City, IN (US)

Correspondence Address: DANTON S. LONG, 138 S. DICKERSON, MICHIGAN CITY, IN, 46360, US

(21) Appl. No.: 11/709,465

(22) Filed: Feb. 22, 2007

(51) Int. Cl. G06Q 40/00

(52) U.S. Cl. 705/37

(57) ABSTRACT

A method for detecting wave volatility involves an objective definition for trend development. A new labeling scheme for monitoring price movements in the market categorizes development and degree of trend automatically. A means for detecting degree of trend involves a novel use of a mathematical equation for detecting trend development by detecting distance retraces a portion of its peak to trough movement.

### BACKGROUND

Ralph Nelson Elliott developed the Elliott Wave Theory in the late 1920s by analyzing stock markets and price movements in waves. Elliott stated that people have psychological upward and downward mood swings and as a result, stock markets have an upward and downward oscillatory nature. In addition, he understood that stock markets and price movements have a fractal nature. Fractals are structures, which on an ever-smaller scale, infinitely repeat themselves.

Elliott analyzed stock markets in great detail combining a wave theory with a notion that waves repeat themselves. He identified wave patterns based on a repeating series of eight waves: five waves go with the main trend followed by three waves against the main trend. An impulsive wave, which goes with the main trend, always shows five waves in its pattern. A corrective wave, which goes against the main trend, always shows three waves in its pattern.

Within each one of these impulsive waves, five more waves can be found. In this smaller pattern, the same pattern repeats itself until analysis of the most minute time frame reveals the smallest wave. These larger to smaller patterns are labeled as different wave degrees in the Elliott Wave Theory.

Elliott's Wave Theory involves the following guidelines: first, there are five waves in the direction of the main trend followed by three corrective waves (a “5-3” move); second, a 5-3 move completes a cycle; third, the 5-3 move then becomes two subdivisions of the next higher 5-3 wave; and fourth, the underlying 5-3 pattern remains constant, although the time span of each may vary. He labeled the impulse waves with a series of numbers: 1, 2, 3, 4, 5; these five numbers are used to define the main trend. Corrective waves are labeled with a series of letters: a,b,c; and represent contra-trend moves, i.e. price movements against the main trend.

FIG. 1 illustrates Elliott's wave with a chart made up of eight waves (five up and three down) which are labeled 1, 2, 3, 4, 5, A, B and C. Waves 1,3,5,A and C move in the direction of the main trend and waves 2,4, and B move against the main trend. The waves against the trend are corrections and are composed of three waves.

Elliott's wave principle assigns nine degrees of a trend or cycle to the fractal nature of the waves which he categorized by intensity and duration. The smallest cycle was the subminuette degree which lasts a few hours. The largest cycle is the Grand Supercycle degree which lasts at least one hundred years. The fractal nature of the waves in order of the largest degree to the smallest degree respectively includes: Grand Supercycle, Supercycle, Cycle, Primary, Intermediate, Minor, Minute, Minuette, and Sub-Minuette.

Analysts routinely experience problems with Elliott's wave pattern when trying to get real market data to fit within the eight wave cycle. Sometimes price movements occur in patterns different from five impulse waves followed by three corrective waves. Unfortunately, Elliott's solution to this problem involved reclassification or re-labeling the waves in order to obtain a desired outcome.

In addition, Elliott's rules require that wave three is the largest, wave two should not retrace more than 100% of wave one, and wave four should never overlap wave one. Elliott's analysis lacks a quantitative and systematic process to measure wave movements or wave degrees. Moreover, analysts find it difficult to determine where one wave begins and another ends, they lack ability to-forecast wave movements within a larger wave degree, and they constantly question the derived wave count. As a result, analysts question the validity of their findings and consider other forms of investment analysis to support their findings.

### SUMMARY

Accordingly, the present invention is directed to methods for analyzing distribution patterns following a shock to define, categorize, display, and label trend development in a quantitative and systematic manner. In essence it simplifies the fractal composition of price markedly different from what Elliott proposed. In one aspect of the invention, it categorizes how price develops naturally in one continuous peak to tough movement across nine degrees of trend.

A second aspect of the invention involves detecting a distance price retraces its peak to trough movement. The distance price retraces its peak to trough movement is detected using a mathematical equation. Embodiments of mathematical equations involve those selected from the group consisting of y=mx+b, the mathematical equation of a straight line, and y=Asin(2πft)×=Acos(2πft) and y=Asin(2πft−290 x/λ), mathematical equations associated with waves.

A detection means for detecting when price passes through a price value involves use of y=mx+b; y=Asin(2πft); x=Acos(2πft); or y=Asin(2πft−2πx/λ). The invention then displays a symbol, a label, illustrates whether the movement is corrective, impulsive, or neither, and illustrates a degree of trend of the price movement. When the movement is neither impulsive nor corrective the movement is inside movement.

After detection of the distance price retraces its peak to trough movement, another aspect of the invention sends the user a signal illustrating the beginning and endpoint for each movement, the type of movement, and displaying a label and a symbol. It assigns to each wave movement a label comprising a pair of characters without use of any letters. The pair of characters reveals the degree of trend and whether the wave is an impulsive wave of a corrective move, or neither. The first character of the pair is on the left and reveals the degree of trend. The second character reveals whether the wave is an impulse movement or a corrective movement and is on the right of the pair.

An impulse wave movement is a movement that moves in the direction of the main trend. These movements are labeled as the second of the pair of numbers always as odd numbered counts: 1,3,5,7,9,11, etc. A corrective wave is a movement that moves against the main trend. These movements are labeled as the second of the pair of numbers and always have even numbered counts: 2,4,6,8,10, etc.

Degrees of trend are labeled as the first of the pair with a number from 1 to 9 wherein 1 is the smallest degree of trend and 9 is the largest degree of trend. The larger degree of trend should extend longer and result in greater profit expectation than development on a smaller degree of trend.

### DETAILED DESCRIPTION

The invention involves a procedure to measure wave volatility. The invention characterizes volatility by detecting the distance price retraces a portion of its previous peak to trough movement.

A one wave movement is defined as a single peak to trough wave movement. The movement will always have impulse characteristics, because it is the only movement that can develop on its own. FIG. 2. A two wave movement is defined by two individual peak to trough movements. One of the movements is impulsive and the other is corrective. In reference to FIG. 3, a three wave movement is defined by three individual peak to trough movements. Two of these movements will be impulsive and the other corrective.

The label itself involves two characters separated by a separator, wherein the separator comprises a hyphen. The number to the left of the hyphen illustrates degree of trend. The number to the right of the hyphen illustrates a certain type of wave movement. A preferred embodiment involves labeling impulsive movements with an odd number to the right of the hyphen. It is preferred to label corrective movements with an even number to the right of the hyphen.

An outline of labeling the degrees of trend involves the following guidelines: first, there are nine degrees of trend and second, labeling degrees of trend occurs on the left character. The labeling begins on the smallest degree of trend and increases in sequence to the ninth degree of trend. Degrees 1 through 8 are labeled as numbers and always on the left character: 1 for first degree of trend, 2 for second degree of trend, 3 for third degree of trend, 4 for fourth degree of trend, 5 for fifth degree of trend, 6 for sixth degree of trend, 7 for seventh degree of trend, 8 for eighth degree of trend. For example, in FIG. 4, the five wave movement on the first degree (1-1, 1-2, 1-3, 1-4, 1-5) of trend (when viewed off the extreme low) is labeled as a larger 2-1, simply because price retracement following the 1-5, extended low enough to confirm completed development on the first degree of trend and on the second degree of trend. Had price shown more strength and not retraced significantly, the first degree wave series would have continued upward showing a 1-6.

The use of mathematical equations: y=mx+b; y=Asin(2πft); x=Acos(2πft); and y=Asin(2πft=2πx/λ) allows detection of price movement. If price retracement is large, the detector reveals that the movement is impulsive, assigns a label indicative of its impulsive nature and assigns a label indicative of degree of trend. If price retracement is small, the detector reveals that the movement is corrective, assigns a label indicative of its corrective nature, and assigns a label indicative of degree of trend.

Another example involves FIG. 5. Notice how 1-2 and 1-4 are corrective movements which move towards their supporting trend line. If the retracement, the amount price retraces a peak to trough distance, had over extended a limit for trend development (here shown as y=mx+b), their development would not represent corrective waves, but a new impulse wave down.

In addition to numbers, the invention involves use of symbols to illustrate degree of trend. An example of a symbol is color. A preferred embodiment of the use of color on the first degree of trend is red, second degree of trend is orange, third degree of trend is blue, fourth degree of trend is green, fifth degree of trend light blue, and sixth degree of trend magenta. Other symbols are within the scope of the invention.

In reference to FIG. 6, impulse movements on the lowest degree of trend are labeled adjacent price while the impulse movements on the highest degree of trend are labeled farthest from price. Corrective waves are labeled as even numbers in an inverse succession where the lowest degrees of trend are labeled adjacent price and the highest degrees of trend are labeled farthest from price.

Labeling is an automatic process wherein a plurality of symbols, including a plurality of colors, illustrates different degrees of development.

In order to identify trend, the invention involves a means for detecting where one trend ends and another begins. It contains a means for detecting when one wave ends and another ends. The means for detecting where one trend ends and another begins, are selected from the group consisting of y=mx+b the mathematical equation of a straight line; and y=Asin(2πft); x=Acos(2πft); and y=Asin(2πft−2πx/λ) the mathematical equations associated with a wave. A preferred mathematical equation is an equation for a wave moving forward: y=Asin(2πft−2πx/λ). The invention uses y=Asin(2πft−2πx/λ) to detect when the wave count retraces a portion of its peak to trough movement. The invention in one embodiment includes a means to receive financial data and display the financial data in wave-like displays. When the data reaches a peak and then moves downward a means for detecting that downward movement involves use of mathematical equations. When the distance price retraces its peak to trough movement reaches a limit of y=mx+b, a signal is sent to a data processor and an output of a symbol and a label is displayed adjacent the wave. The invention determines what type of development is unfolding: impulsive or corrective. Then a label results to categorize development and degree of trend. The label results in a colored scheme of two characters separated by a separator.

The method involves use of a computer and a data processor wherein means for detecting distance price retraces a portion of its peak to trough movement comprises a first and second limit detector, the first and second limit detector having mathematical equations, such that the mathematical equations of the limit detectors are at a predetermined relative position with respect to each other, the first and second limit detectors logically connected to the means for receiving price data and logically connected to the means for displaying price waves. The limit detectors are set to detect movement about lines selected from the group of mathematical equations wherein y=selected from the group consisting of an open price, a closing price, a low price, and a high price.

### BRIEF DESCRIPTION OF THE DRAWINGS

FIG. 1 is a chart of eight waves illustrating Elliott's labeling system

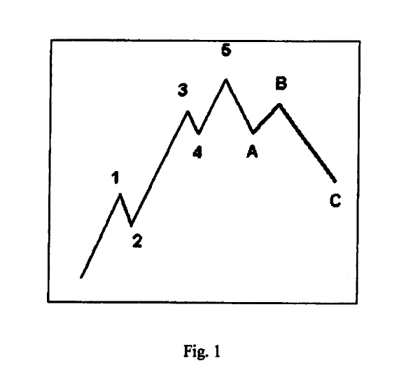

FIG. 2 is an illustration of a peak and a trough of a one wave movement

FIG. 3 is an illustration of wave development

FIG. 4 illustrates the labeling scheme of a five wave movement on the first degree of trend.

FIG. 5 illustrates corrective waves.

FIG. 6 illustrates an embodiment of a chart of the invention

### DETAILED DESCRIPTION OF THE DRAWINGS

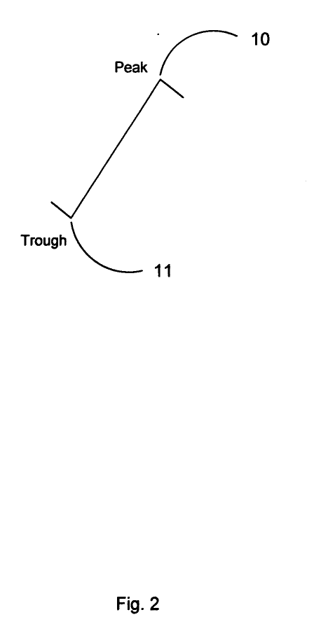

Referring to FIG. 2, a one wave movement has a peak 10 and a trough 11. A one wave movement is always impulsive.

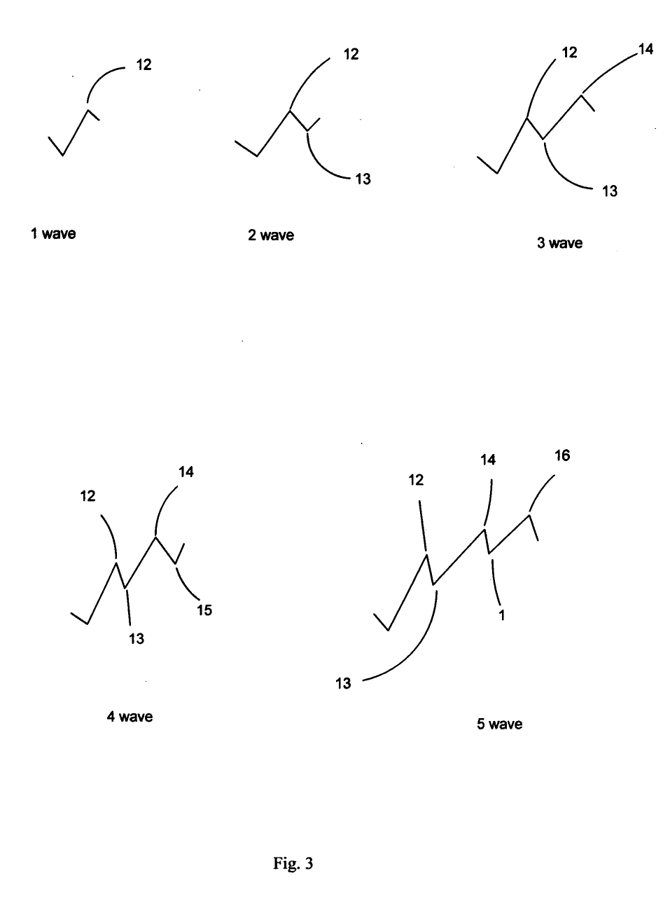

A two wave movement in FIG. 3 has an impulsive movement 12 and a corrective movement 13. A three wave movement in FIG. 3 has the first impulsive movement 12, the corrective movement 13 and a second impulsive movement 14. A four wave movement has the first impulsive movement 12, the first corrective movement 13 movement, the second impulsive movement 14, and a second corrective movement 15. A five wave movement has the first impulsive movement 12, the first corrective movement 13, the second impulsive movement 14, the second corrective movement 15, and a third impulsive movement 16.

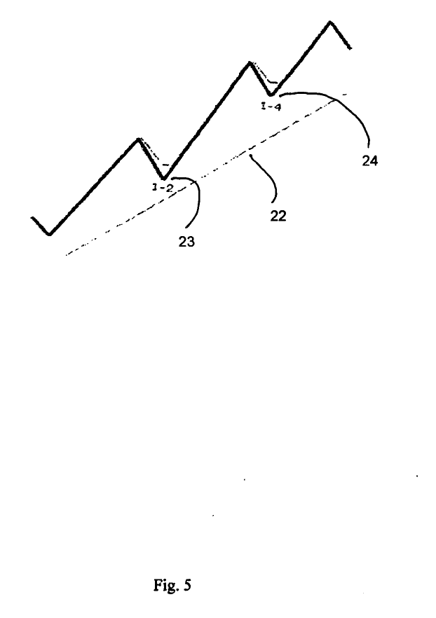

A means for detecting a distance price retraces a portion of its peak to trough movement is shown in FIG. 5 by the straight line 22. Since 22 and 24 fail to cross 22, the symbol for a corrective movement appears. Had 23 and 24 crossed the straight line, their symbols would indicate impulsive movement.

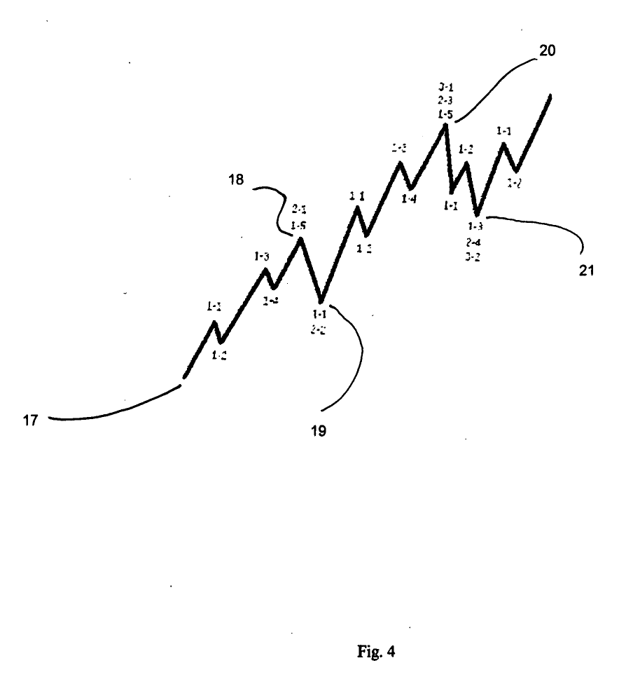

Referring to FIG. 4 development is labeled with a series of pairs of digits. The degree of trend is the digit on the left and the designation of impulsive or corrective is the digit on the right. The five wave movement 18 on the first degree of trend off the low 17 is labeled as a larger 2-1. An impulsive movement 19 gets a 1-1 label to reveal its impulsive movement on the first degree of trend and also a 2-2 label to show it is a corrective movement on the second degree of trend. The second five wave movement 20 on the first degree of trend following 19 is labeled a 1-5. 2-3, and 3-1.

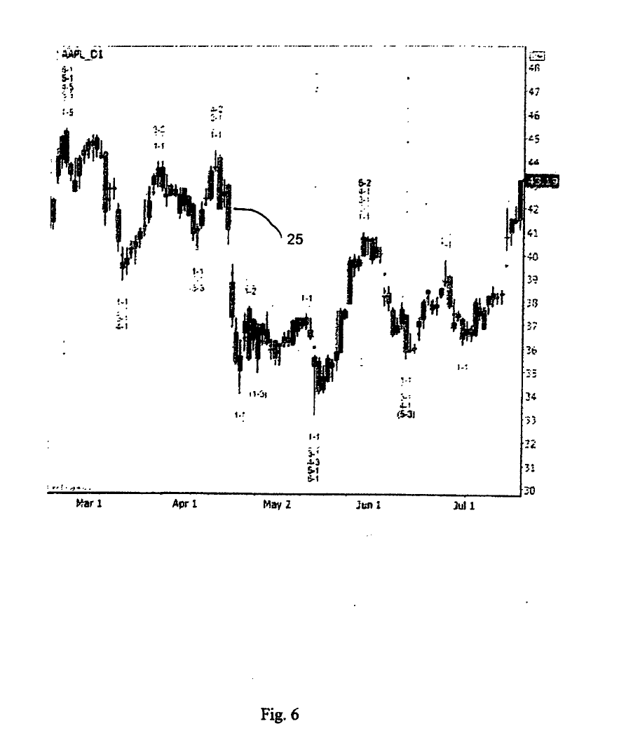

The labels in FIG. 4 include a color scheme. Labels on the first degree of trend 1-11-2. 1-3. 1-4, and 1-5 show up as one color labels on the second degree of trend 2-1. 2-2, 2-3, and 2-4 are a second color, and labels on the third degree of trend 3-1 and 3-2 are a third color. In FIG. 6, labels on the fourth degree of trend 4-5. 4-1, 4-2. 4-3. 4-1, and 4-1 involve a fourth color.

In FIG. 6 an indicia of price is shown by bar 25. Price in bar 25 includes open, close. high, and low prices.

1. A method measuring wave volatility comprising: displaying price movement in waves; using a means for detecting said price movement within a plurality of limits, characterizing said waves as corrective with an even number or impulsive with an odd number, identifying a degree of trend, and displaying a symbol.

2. A method for measuring wave volatility comprising: displaying price movement in waves; using a means for detecting a distance price retraces a portion of its peak to trough movement, characterizing said waves as corrective or impulsive, characterizing said corrective waves with an even number, characterizing said impulsive waves with an odd number, identifying a degree of trend, characterizing a degree of trend, and displaying a symbol.

3. A method for measuring wave volatility according to claim 2: wherein said means for detecting a distance price retraces a portion of its peak to trough movement comprises using at least one mathematical equation.

4. A method for measuring wave volatility according to claim 3 wherein said mathematical equation comprises x=Acos(2πft).

5. A method for measuring wave volatility according to claim 3 wherein said mathematical equation comprises y=Asin(2πft−2πx/λ).

6. A method for measuring wave volatility according to claim 3 wherein said mathematical equation comprises y=Asin(2πft).

7. A method measuring wave volatility according to claim 3 wherein said mathematical equation comprises y=mx+b.

8. A method for measuring wave volatility according to claim 2 further comprising displaying said price movement using y=Asin(2πft−2πx/λ), using a means for detecting distance price retraces a portion of its peak to trough movement, using a plurality of limit detectors, said plurality of limit detectors having sensing means, such that the sensing means of the limit detectors are at a predetermined relative position with respect to each other, said plurality of limit detectors logically connected to the means for receiving price data and logically connected to the means for displaying price waves.

9. A method for measuring wave volatility according to claim 8 wherein said sensing means comprise a plurality of price values.

10. A method for measuring wave volatility according to claim 8 wherein means for detecting a distance price retraces a portion of its peak to trough movement comprises indicia of four prices.

11. A method for measuring wave volatility according to claim 8 wherein means for detecting distance price retraces a portion of its peak to trough movement comprises indicia of three prices

12. A method for measuring wave volatility according to claim 8 wherein means for detecting distance price retraces a portion of its peak to trough movement comprises indicia of two prices.

13. A method for measuring wave volatility according to claim 8 wherein means for detecting distance price retraces a portion of its peak to trough movement comprises indicia of a price.

14. A method for measuring wave volatility according to claim 12 wherein said indicia of four prices comprises indicia of an open, a close, a high, and a low price.

15. A method measuring wave volatility comprising: displaying price movement in waves according to y=Asin(2πft−2πx/λ); using a means for detecting said price movement within a plurality of limits, using a means for detecting distance price retraces a portion of its peak to trough movement, characterizing said waves, identifying a degree of trend, and displaying a symbol, displaying said degree of trend with a color.

16. A method for measuring wave volatility according to claim 15 further comprising said distance price retraces a portion of its peak to trough movement is impulsive if said distance price retraces a portion of its peak to trough movement is greater than a limit set by a mathematical equation.

17. A method for measuring wave volatility according to claim 15 further comprising said distance price retraces a portion of it peak to trough, and labeling as corrective if said distance price retraces a portion of its peak to trough movement is less than a limit set by a mathematical equation.
